(19) United States
(12) Patent Application Publication
(10) Pub. No.: US 2024/0161279 A1
(43) Pub. Date: May 16, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Shigeru NAKAMURA, Tokyo (JP)

(73) Assignee: NEC Corporation, Minato-ku, Tokyo (JP)

(21) Appl. No.: 18/281,266

(22) PCT Filed: Dec. 27, 2021
(86) PCT No.: PCT/JP2021/048535

§ 371 Date: Sep. 8, 2023

(30) Foreign Application Priority Data
Mar. 17, 2021 (JP) 2021-043015

(51) Int. Cl. G06T 7/00; G06T 7/50; G06T 11/00; G06V 10/44; G06V 10/60

(52) U.S. Cl. CPC G06T 7/0012; G06T 7/50; G06T 11/00; G06V 10/44; G06V 10/60; G06T 2207/10072; G06T 2207/30088

(57) ABSTRACT

There is provided an information processing apparatus including a first acquisition means for acquiring a first feature amount acquired from luminance data of a first plane facing a surface of a skin among three-dimensional luminance data of the skin, a second acquisition means for acquiring a second feature amount acquired from luminance data of a second plane including a depth direction of the skin among the three-dimensional luminance data, and a calculation means for calculating an extraction depth for extraction of a pattern of the skin based on the first feature amount and the second feature amount.

### TECHNICAL FIELD

This disclosure relates to an information processing apparatus, an information processing method, and a storage medium.

### BACKGROUND ART

PTL 1 discloses a dermal image information processing apparatus including a dermal image information acquisition unit that acquires image information indicating an image of a papillary layer of skin and a peculiar region detection unit that detects a peculiar region indicating damage to the papillary layer based on the acquired image information.

### CITATION LIST

### Patent Literature

PTL 1: International Publication No. 2016/204176

### SUMMARY OF INVENTION

### Technical Problem

In biometric authentication based on a pattern of skin such as PTL 1, there is a demand for a technique capable of increasing the accuracy of biometric information in order to improve the accuracy of authentication.

It is an example object of this disclosure to provide an information processing apparatus, an information processing method, and a storage medium capable of increasing the accuracy of biometric information based on a pattern of a skin.

### Solution to Problem

According to an aspect of this disclosure, there is provided an information processing apparatus including a first acquisition means for acquiring a first feature amount acquired from luminance data of a first plane facing a surface of a skin among three-dimensional luminance data of the skin, a second acquisition means for acquiring a second feature amount acquired from luminance data of a second plane including a depth direction of the skin among the three-dimensional luminance data, and a calculation means for calculating an extraction depth for extraction of a pattern of the skin based on the first feature amount and the second feature amount.

According to another aspect of this disclosure, there is provided an information processing method including acquiring a first feature amount acquired from luminance data of a first plane facing a surface of a skin among three-dimensional luminance data of the skin, acquiring a second feature amount acquired from luminance data of a second plane including a depth direction of the skin among the three-dimensional luminance data, and calculating an extraction depth for extraction of a pattern of the skin based on the first feature amount and the second feature amount.

According to another aspect of this disclosure, there is provided a storage medium storing a program for causing a computer to execute an information processing method including acquiring a first feature amount acquired from luminance data of a first plane facing a surface of a skin among three-dimensional luminance data of the skin, acquiring a second feature amount acquired from luminance data of a second plane including a depth direction of the skin among the three-dimensional luminance data, and calculating an extraction depth for extraction of a pattern of the skin based on the first feature amount and the second feature amount.

### BRIEF DESCRIPTION OF DRAWINGS

FIG. 1 is a block diagram illustrating a hardware configuration example of an information processing apparatus according to a first example embodiment.

FIG. 2 is a functional block diagram of the information processing apparatus according to the first example embodiment.

FIG. 3A is a schematic diagram illustrating a configuration example of a three-dimensional measuring apparatus according to the first example embodiment.

FIG. 3B is a schematic diagram illustrating a configuration example of the three-dimensional measuring apparatus according to the first example embodiment.

FIG. 3C is a schematic diagram illustrating a configuration example of the three-dimensional measuring apparatus according to the first example embodiment.

FIG. 3D is a schematic diagram illustrating a configuration example of the three-dimensional measuring apparatus according to the first example embodiment.

FIG. 4 is a flowchart illustrating an outline of an extraction depth calculation executed in the information processing apparatus according to the first example embodiment.

FIG. 5 is a schematic diagram illustrating an outline of the extraction depth calculation executed in the information processing apparatus according to the first example embodiment.

FIG. 6 is a graph illustrating an example of calculation of a first feature amount executed in the information processing apparatus according to the first example embodiment.

FIG. 7A is a diagram illustrating an example of calculation of the first feature amount executed in the information processing apparatus according to the first example embodiment.

FIG. 7B is a diagram illustrating an example of calculation of the first feature amount executed in the information processing apparatus according to the first example embodiment.

FIG. 7C is a diagram illustrating an example of calculation of the first feature amount executed in the information processing apparatus according to the first example embodiment.

FIG. 8 is a diagram illustrating an example of calculation of a second feature amount executed in the information processing apparatus according to the first example embodiment.

FIG. 9 is a diagram illustrating an example of calculation of the second feature amount executed in the information processing apparatus according to the first example embodiment.

FIG. 10 is a diagram illustrating an example of calculation of the second feature amount executed in the information processing apparatus according to the first example embodiment.

FIG. 11A is a graph illustrating an example of score calculation in the information processing apparatus according to the first example embodiment.

FIG. 11B is a graph illustrating an example of score calculation in the information processing apparatus according to the first example embodiment.

FIG. 11C is a graph illustrating an example of score calculation in the information processing apparatus according to the first example embodiment.

FIG. 11D is a graph illustrating an example of score calculation in the information processing apparatus according to the first example embodiment.

FIG. 12 is a functional block diagram of an information processing apparatus according to a second example embodiment.

FIG. 13 is a flowchart illustrating an outline of an extraction depth calculation executed in the information processing apparatus according to the second example embodiment.

FIG. 14 is a diagram illustrating an example of calculation of a third feature amount executed in the information processing apparatus according to the second example embodiment.

FIG. 15 is a diagram illustrating an example of calculation of an extraction depth executed in the information processing apparatus according to the second example embodiment.

FIG. 16 is a graph illustrating an example of score calculation in the information processing apparatus according to the second example embodiment.

FIG. 17 is a flowchart illustrating an outline of an extraction depth calculation executed in an information processing apparatus according to a third example embodiment.

FIG. 18 is a flowchart illustrating an outline of an extraction depth calculation executed in an information processing apparatus according to a fourth example embodiment.

FIG. 19 is a graph illustrating an example of score calculation in the information processing apparatus according to the fourth example embodiment.

FIG. 20 is a flowchart illustrating an outline of an extraction depth calculation executed in an information processing apparatus according to a fifth example embodiment.

FIG. 21 is a functional block diagram of an information processing apparatus according to a sixth example embodiment.

FIG. 22 is a flowchart illustrating an outline of an extraction depth calculation executed in the information processing apparatus according to the sixth example embodiment.

FIG. 23 is a functional block diagram of an information processing apparatus according to a seventh example embodiment.

FIG. 24 is a flowchart illustrating an outline of generation of a pattern image executed in the information processing apparatus according to the seventh example embodiment.

FIG. 25 is a functional block diagram of an information processing apparatus according to an eighth example embodiment.

FIG. 26 is a flowchart illustrating an outline of tomographic image display executed in the information processing apparatus according to the eighth example embodiment.

FIG. 27 is a diagram illustrating an example of an image displayed in the information processing apparatus according to the eighth example embodiment.

FIG. 28 is a functional block diagram of an information processing apparatus according to a ninth example embodiment.

### DESCRIPTION OF EMBODIMENTS

Exemplary embodiments of this disclosure will now be described with reference to the drawings. In the drawings, similar or corresponding elements are denoted by the same reference numerals, and description thereof may be omitted or simplified.

### First Example Embodiment

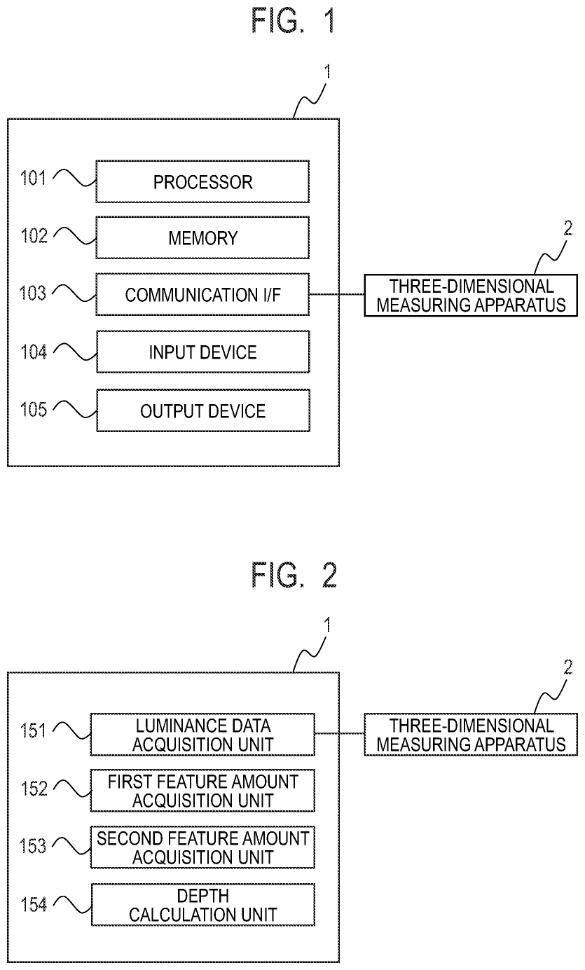

An information processing apparatus 1 according to this example embodiment will be described with reference to FIGS. 1 to 11D. The information processing apparatus 1 according to this example embodiment analyzes data acquired by a three-dimensional measuring apparatus 2. The three-dimensional measuring apparatus 2 is an apparatus that captures an image of a part such as a finger of a person based on a three-dimensional measuring technology such as an optical coherence tomography (OCT) technology, and acquires three-dimensional luminance data including the inside of the skin. The three-dimensional measuring apparatus 2 may be, for example, a fingerprint imaging apparatus. By analyzing the three-dimensional luminance data, the information processing apparatus 1 calculates an extraction depth suitable for extraction of a pattern of the skin. Further, the information processing apparatus 1 may use the three-dimensional luminance data to perform processing relating to biometric authentication such as generation of fingerprint images suitable for fingerprint authentication, registration of fingerprint images, and matching of fingerprint images.

FIG. 1 is a block diagram illustrating a hardware configuration example of the information processing apparatus 1. The information processing apparatus 1 may be a computer such as a data processing server, a desktop personal computer (PC), a notebook PC, or a tablet PC.

The information processing apparatus 1 includes a processor 101, a memory 102, a communication interface (I/F) 103, an input device 104, and an output device 105 as a computer that performs calculation, control, and storage. The units of the information processing apparatus 1 are connected to each other via a bus, wiring, a driving device, and the like (not illustrated).

The processor 101 is, for example, a processing device including one or more arithmetic processing circuits such as a central processing unit (CPU), a graphics processing unit (GPU), a field-programmable gate array (FPGA), and an application specific integrated circuit (ASIC). The processor 101 has a function of performing a predetermined operation in accordance with a program stored in the memory 102 or the like and controlling each unit of the information processing apparatus 1.

The memory 102 may include a volatile storage medium that provides a temporary memory area necessary for the operation of the processor 101, and a non-volatile storage medium that non-temporarily stores information such as data to be processed and an operation program of the information processing apparatus 1. Examples of the volatile storage medium include a random access memory (RAM). Examples of the non-volatile storage medium include a read only memory (ROM), a hard disk drive (HDD), a solid state drive (SSD), and a flash memory.

The communication I/F 103 is a communication interface based on standards such as Ethernet (registered trademark), Wi-Fi (registered trademark), Bluetooth (registered trademark), and the like. The communication I/F 103 is a module for communicating with other apparatuses such as the three-dimensional measuring apparatus 2.

The input device 104 is a keyboard, a pointing device, a button, or the like, and is used by a user to operate the information processing apparatus 1. Examples of the pointing device include a mouse, a trackball, a touch panel, and a pen tablet.

The output device 105 is a device that presents information to a user such as a display device or a speaker. Examples of the display device include a liquid crystal display, an organic light emitting diode (OLED) display, and the like. The input device 104 and the output device 105 may be integrally formed as a touch panel.

It should be noted that the hardware configuration illustrated in FIG. 1 is an example, and other devices may be added, or a part of the devices may not be provided. Some devices may be replaced with other devices having similar functions. Further, some functions of this example embodiment may be provided by other apparatuses via a network, or the functions of this example embodiment may be distributed among a plurality of apparatuses. For example, the information processing apparatus 1 and the three-dimensional measuring apparatus 2 may be integrated with each other. Thus, the hardware configuration illustrated in FIG. 1 can be changed as appropriate.

FIG. 2 is a functional block diagram of the information processing apparatus 1 according to this example embodiment. The information processing apparatus 1 includes a luminance data acquisition unit 151, a first feature amount acquisition unit 152, a second feature amount acquisition unit 153, and a depth calculation unit 154.

The processor 101 performs predetermined arithmetic processing by executing a program stored in the memory 102. The processor 101 controls the memory 102, the communication I/F 103, the input device 104, and the output device 105 based on the program. Thus, the processor 101 realizes functions of the luminance data acquisition unit 151, the first feature amount acquisition unit 152, the second feature amount acquisition unit 153, and the depth calculation unit 154. The first feature amount acquisition unit 152, the second feature amount acquisition unit 153, and the depth calculation unit 154 may be referred to as a first acquisition means, a second acquisition means, and a calculation means, respectively.

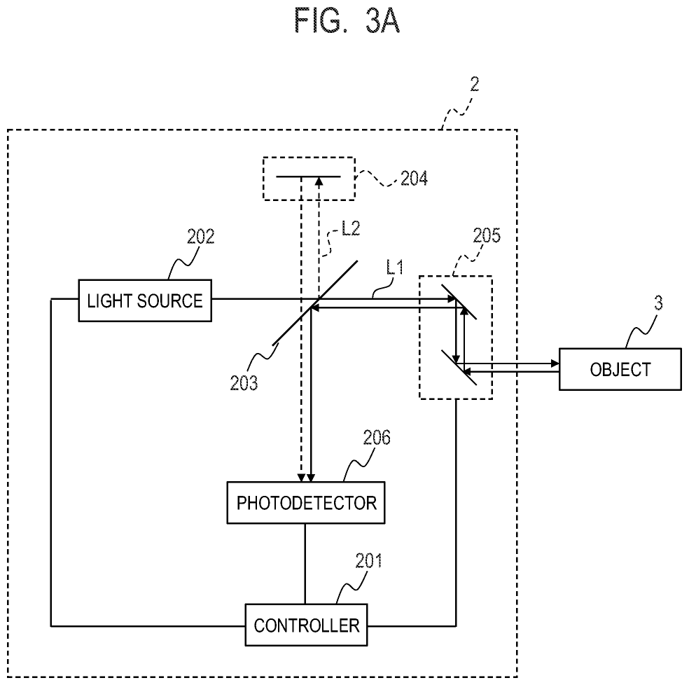

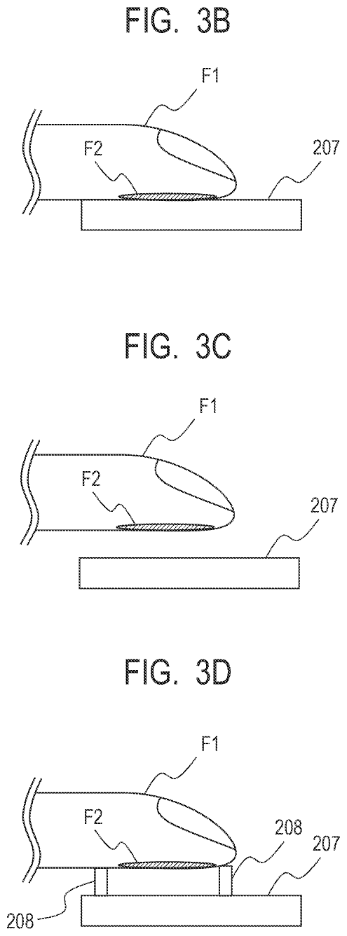

FIGS. 3A to 3D are schematic diagrams illustrating a configuration example of the three-dimensional measuring apparatus 2 according to this example embodiment. In the following description, the three-dimensional measuring apparatus 2 is an apparatus that optically acquires three-dimensional luminance data on the surface and inside of the object 3 using, for example, the optical coherence tomography (OCT) technology. The configurations illustrated in FIGS. 3A to 3D are merely examples of the measuring apparatus using the OCT technology, and other apparatus configurations may be used.

FIG. 3A is a diagram illustrating functional blocks and optical paths constituting the three-dimensional measuring apparatus 2. As illustrated in FIG. 3A, the three-dimensional measuring apparatus 2 includes a controller 201, a light source 202, a beam splitter 203, a reference light mirror 204, a scanner head 205, and a photodetector 206. The controller 201 is a control device that controls each unit of the three-dimensional measuring apparatus 2. The controller 201 may have a data conversion function of converting a signal acquired from the photodetector 206 or the like into digital data of a predetermined standard, or may have a data processing function of analyzing data. The light source 202 is a light source that emits light for measurement such as a wavelength-swept laser. The emitted light can be, for example, near infrared radiation. The beam splitter 203 is an optical member that reflects a part of incident light and transmits another part of the incident light. The reference light mirror 204 reflects light. The scanner head 205 is an optical member that two-dimensionally scans light emitted from the three-dimensional measuring apparatus 2 to the surface of the object 3 within the plane of the object 3. The photodetector 206 may include an optical element, such as a photodiode, that detects the luminance of incident light.

The light emitted from the light source 202 is split by the beam splitter 203 into a light flux L1 directed toward the object 3 and a light flux L2 directed toward the reference light mirror 204. The light flux L1 is irradiated onto the object 3 after the emission direction is adjusted by the scanner head 205. The object 3 is, for example, a finger of a subject of biometric authentication.

FIGS. 3B to 3D are diagrams illustrating three arrangement examples of a measurement table 207 when the three-dimensional measuring apparatus 2 is a fingerprint detecting device and the object 3 is a finger F1 of the subject. FIG. 3B is a diagram illustrating a positional relationship between the finger F1 and the measurement table 207 in a first example. The first example is a contact-type configuration example in which measurement is performed in a state where the finger F1 and the measurement table 207 are in contact with each other. The measurement table 207 may be made of a transparent material such as glass. The subject presses the finger F1 on the measurement table 207. In this state, the light flux L2 is emitted from the scanner head 205 to the finger F1 through the measurement table 207, whereby the surface of the finger F1 is irradiated with light, and the light is backscattered on the surface and inside of the finger F1. In this way, the light backscattered by the object 3 is incident on the photodetector 206 as object light via the scanner head 205 and the beam splitter 203 in this order. The light flux L2 is reflected by the reference light mirror 204 and is incident on the photodetector 206 as reference light. The photodetector 206 detects interference light between the object light and the reference light. The controller 201 acquires a signal based on the interference light. In this example, since the fingerprint F2 of the finger F1 is pressed against the measurement table 207, the fingerprint F2 can be appropriately positioned.

FIG. 3C is a diagram illustrating a positional relationship between the finger F1 and the measurement table 207 in a second example. The second example is a non-contact configuration example in which measurement is performed in a state where the finger F1 and the measurement table 207 do not contact each other. Also in this configuration, the measurement can be performed by a process substantially similar to that described above except that the finger F1 does not contact the measurement table 207. In this example, deformation of the fingerprint F2 due to contact of the fingerprint F2 with the measurement table 207 is less likely to occur. Further, it is hygienic because the finger F1 does not touch the measurement table 207. In this example, the measurement table 207 may not be provided. In this case, the light flux L2 is directly incident on the finger F1 from the scanner head 205 without passing through the measurement table 207.

FIG. 3D is a diagram illustrating a positional relationship between the finger F1 and the measurement table 207 in a third example. The third example is another configuration example of a non-contact type in which the finger F1 and guides 208 are in contact with each other, but measurement is performed in a non-contact state between the finger F1 and the measurement table 207. Also in this configuration, the measurement can be performed by a process substantially similar to that described above except that the finger F1 does not contact the measurement table 207. In this example, deformation of the fingerprint F2 due to contact of the fingerprint F2 with the measurement table 207 is less likely to occur. Further, the fingerprint F2 can be appropriately positioned by the guides 208. The measurement table 207 and the guides 208 may be integrally formed of the same member, or may be formed of different members. The three-dimensional measuring apparatus 2 may be configured to be capable of switching two or three measurement states from the first example to the third example. Although three examples of the arrangement of the measurement table 207 of the three-dimensional measuring apparatus 2 have been described above, the configuration of the three-dimensional measuring apparatus 2 is not limited thereto.

The interference light is detected while sweeping the frequency of the light emitted from the light source 202. In this case, the frequency of the object light changes according to the depth at which backscattering occurs inside the object 3. Accordingly, luminance information of the object 3 in the depth direction can be acquired by analyzing the frequency spectrum of the interference light. Further, two-dimensional luminance information in the plane of the object 3 can be acquired by scanning the exit position of the light flux L1 in the plane of the object 3 by the scanner head 205. By integrating these pieces of luminance information, the three-dimensional measuring apparatus 2 of this example embodiment can measure three-dimensional luminance data including the inside of the object 3. The controller 201 supplies the three-dimensional luminance data acquired by performing these controls to the information processing apparatus 1.

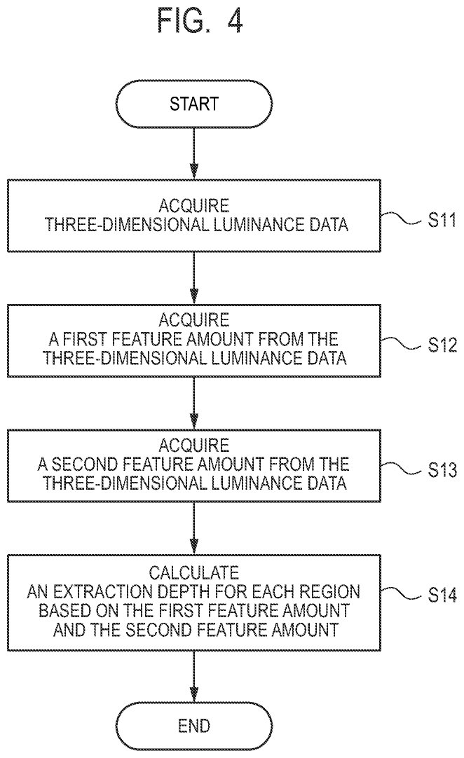

FIG. 4 is a flowchart illustrating an outline of an extraction depth calculation executed in the information processing apparatus 1 according to this example embodiment. This processing is executed, for example, when new three-dimensional luminance data is measured by the three-dimensional measuring apparatus 2.

In step S11, the luminance data acquisition unit 151 acquires three-dimensional luminance data acquired by measuring the finger of the subject with the three-dimensional measuring apparatus 2. This processing may be performed by controlling the three-dimensional measuring apparatus 2 to newly acquire three-dimensional luminance data, or may be performed by reading three-dimensional luminance data acquired in advance from a storage medium such as the memory 102.

In step S12, the first feature amount acquisition unit 152 acquires a first feature amount from the three-dimensional luminance data. Here, the first feature amount is a feature amount acquired from the luminance data of a first plane facing a surface of a skin among the three-dimensional luminance data.

In step S13, the second feature amount acquisition unit 153 acquires a second feature amount from the three-dimensional luminance data. Here, the second feature amount is a feature amount acquired from the luminance data of a second plane including a depth direction of the skin among the three-dimensional luminance data.

In step S14, the depth calculation unit 154 calculates an extraction depth for each region in the three-dimensional luminance data based on the first feature amount and the second feature amount. Here, the extraction depth is information indicating a depth suitable for extraction of a pattern of the skin in each region. The position corresponding to this extraction depth may specifically be in the vicinity of a surface of a dermis, that is, in the vicinity of the boundary between an epidermis and the dermis.

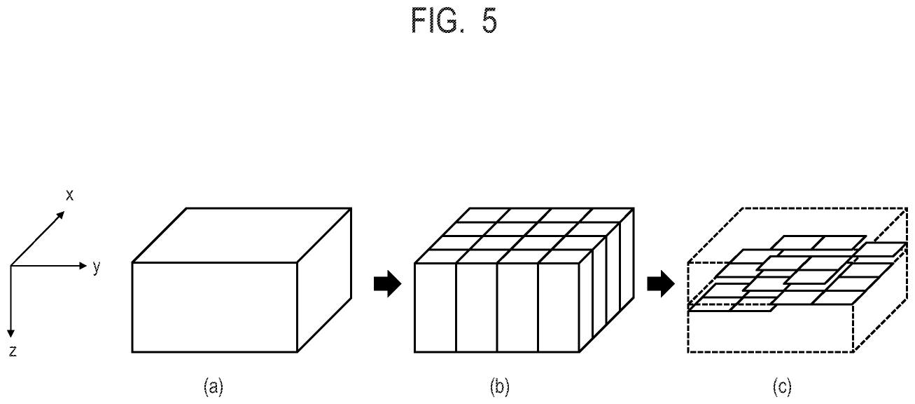

Next, with reference to FIGS. 5 to 10, an example of a specific process of acquiring the first feature amount, the second feature amount, and the extraction depth will be described. FIGS. 5(a) to 5(c) are schematic diagrams illustrating an outline of the extraction depth calculation executed in the information processing apparatus 1 according to this example embodiment. FIG. 5(a) schematically illustrates a region in which the three-dimensional luminance data of the object 3 is acquired by a rectangular parallelepiped. The xy plane described in the coordinate axes illustrated in FIG. 5(a) corresponds to the scanning plane of the light emitted from the three-dimensional measuring apparatus 2. The z direction corresponds to the depth direction of the object 3. In other words, when the object 3 is a finger, the xy plane corresponds to the surface on which the fingerprint of the finger exists (the palm-side surface of the finger) and the z direction corresponds to the depth direction of the finger (the inner direction of the skin).

FIG. 5(b) is a diagram illustrating a region division method of the three-dimensional luminance data of the object 3. As illustrated in FIG. 5(b), in this processing, the xy plane is divided into lattices. The calculation of the first feature amount, the second feature amount, and the extraction depth is performed for each region. The size of the xy plane of the three-dimensional luminance data is, for example, about 24 mm×16 mm, and the size of one region after division is, for example, about 1.5 mm square. FIG. 5(c) is a diagram schematically illustrating the extraction depth calculated in each region. As illustrated in FIG. 5(c), since the extraction depth is calculated individually for each region, the calculated extraction depth can be different values for each region.

As described above, in the extraction of the first feature amount, the feature amount is extracted by an algorithm using the distribution of luminance data on the first plane facing the surface of the skin, that is, in the xy plane in FIG. 5(a). The algorithm for extracting the feature amount may be, for example, an algorithm for extracting a stripe pattern sharpness for a stripe pattern such as a fingerprint. The stripe pattern sharpness can be, for example, a feature amount indicating that a plurality of stripes formed by light and dark in an image exist and have a similar shape, such as an orientation certainty level (OCL). Examples of the evaluation index corresponding to the stripe pattern sharpness include the OCL, a ridge valley uniformity (RVU), a frequency domain analysis (FDA), a local clarity score (LCS), and an orientation flow (OFL). The RVU indicates the uniformity of the width of the light and dark stripes in a small region. The FDA indicates a single frequency characteristic of a stripe pattern in a small region. The LCS indicates the uniformity of luminance for each light and dark portion of a stripe in a small region. The OFL indicates continuity in the direction of stripes with the surrounding small region. These evaluation indices may be used alone and defined as the stripe pattern sharpness, or a plurality of these evaluation indices may be combined and defined as the stripe pattern sharpness.

As an example of the extraction of the first feature amount, an outline of a method of calculating the OCL value indicating the stripe pattern sharpness by the OCL will be described. The luminance on the xy plane at a certain depth is denoted by I(x, y). Here, x and y of arguments mean the x-direction and y-direction region coordinates illustrated in FIG. 5(a), respectively. Here, luminance gradients fx and fy in the x direction and the y direction are defined by the following expressions (1) and (2), respectively.

$$\begin{matrix}[ Math . 1 ] & \\ {f}_{x} = \frac{I ( x + 1 , y ) - I ( x - 1 , y )}{2} & ( 1 )\end{matrix}$$

$$\begin{matrix}[ Math . 2 ] & \\ {f}_{y} = \frac{I ( x , y + 1 ) - I ( x , y - 1 )}{2} & ( 2 )\end{matrix}$$

Here, a variance-covariance matrix C is defined by the following expressions (3) to (6) using variance and covariance of the luminance gradients fx and fy.

$$\begin{matrix}[ Math . 3 ] & \\ C = [ \begin{matrix}a & c \\ c & b\end{matrix} ] & ( 3 )\end{matrix}$$

$$\begin{matrix}[ Math . 4 ] & \\ a = \overline{{f}_{x}^{2}} & ( 4 )\end{matrix}$$

$$\begin{matrix}[ Math . 5 ] & \\ b = \overline{{f}_{y}^{2}} & ( 5 )\end{matrix}$$

$$\begin{matrix}[ Math . 6 ] & \\ c = \overline{{f}_{x} \cdot {f}_{y}} & ( 6 )\end{matrix}$$

Here, the variance-covariance matrix C of two rows and two columns generally has two eigenvalues. Assuming that the smaller one and the larger one of the two eigenvalues are λmin and λmax, respectively, λmin and λmax can be represented by the following expressions (7) and (8), respectively.

[Math. 7]

$${λ}_{min} = \frac{a + b - \sqrt{{( a - b )}^{2} + 4 {c}^{2}}}{2} \qquad ( 7 )$$

$$\begin{matrix}[ Math . 8 ] & \\ {λ}_{max} = \frac{a + b + \sqrt{{( a - b )}^{2} + 4 {c}^{2}}}{2} & ( 8 )\end{matrix}$$

Here, the OCL value in a certain local region can be expressed by the following expression (9).

$$\begin{matrix}[ Math . 9 ] & \\ {Q}_{OCL}^{local} = \{ \begin{matrix}1 - \frac{{λ}_{min}}{{λ}_{max}} , & if {λ}_{max} > 0 \\ 0 , & otherwise\end{matrix} & ( 9 )\end{matrix}$$

This processing corresponds to a principal component analysis for the luminance gradient. The OCL value of expression (9) is a function that is large when the ratio λmin/λmax of the eigenvalues of the variance-covariance matrix C based on the luminance gradients fx and fy in the two directions is small. The case where the ratio λmin/λmax of the eigenvalues is small is a case where a luminance gradient in a certain direction in the xy plane is large and a luminance gradient in a direction perpendicular thereto is small. In other words, the OCL value increases as the stripe pattern flowing in one direction clearly appears in the local region.

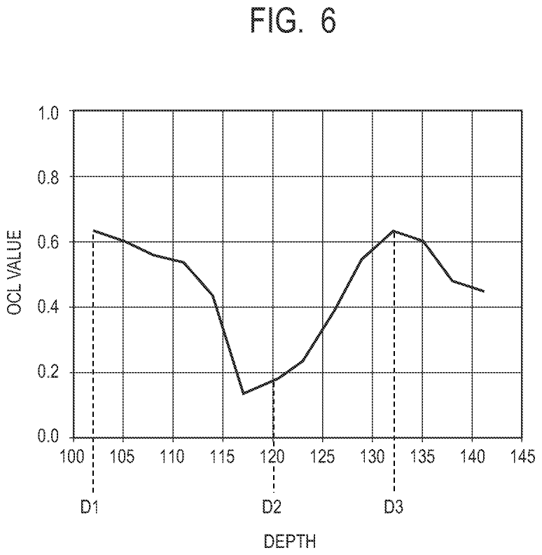

FIG. 6 is a graph illustrating an example of calculation of the first feature amount executed in the information processing apparatus 1 according to this example embodiment. FIG. 6 illustrates an example in which the OCL value is calculated for one local region of the three-dimensional luminance data acquired by measuring a finger. The horizontal axis in FIG. 6 represents the depth of the finger. The smaller the depth value, the closer to the surface of the finger's skin, and the larger the depth value, the closer to the inside of the finger. The vertical axis represents the OCL value as indicated in expression (9). The value of the depth illustrated in FIG. 6 is given by arbitrary units.

As illustrated in FIG. 6, the OCL value indicates a high value at a depth D1 near the surface of the finger. Since the depth D1 is in the vicinity of the surface of the epidermis and the fingerprint of the epidermis clearly appears at this position, the OCL value at the depth D1 is large. At a depth deeper than the depth D1, the OCL value decreases and becomes a local minimum near the depth D2. Since the depth D2 is inside the epidermis and the fingerprint becomes blurred, the OCL value at the depth D2 is small. Further, at a depth deeper than the depth D2, the OCL value rises and becomes a local maximum near the depth D3. Since the depth D2 is close to the surface of the dermis and the dermis fingerprint appears, the OCL value at the depth D3 is large. As described above, based on the distribution of the OCL value, it can be determined that the extraction depth suitable for extraction of the dermal fingerprint is near the depth D3.

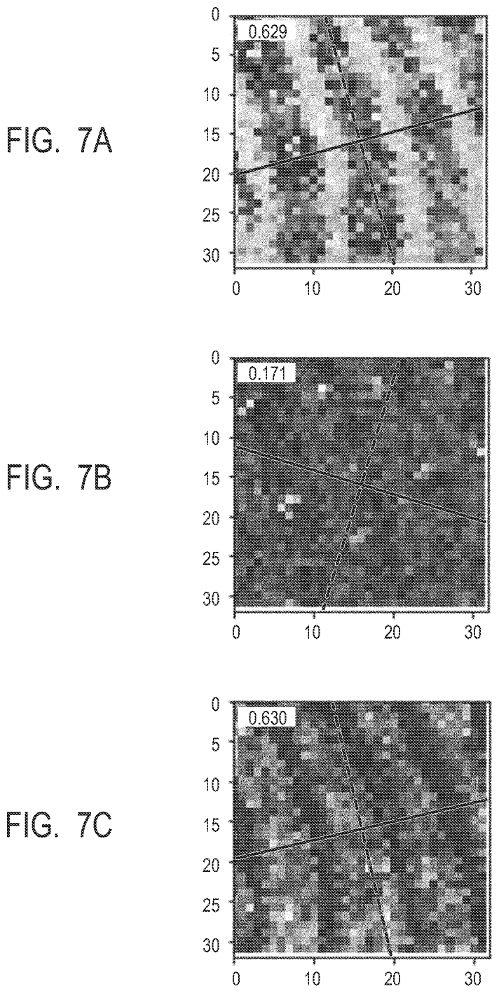

FIGS. 7A to 7C are diagrams illustrating an example of calculation of the first feature amount executed in the information processing apparatus 1 according to this example embodiment. FIG. 7A is a fingerprint image in the xy plane at the depth D1, FIG. 7B is a fingerprint image in the xy plane at the depth D2, and FIG. 7C is a fingerprint image in the xy plane at the depth D3. In FIGS. 7A to 7C, a solid line illustrated in the image indicates a direction of an eigenvector corresponding to the eigenvalue λmax, and a broken line indicates a direction of an eigenvector corresponding to the eigenvalue λmin. In other words, the solid line indicates a direction perpendicular to the detected stripe pattern, and the broken line indicates a direction parallel to the detected stripe pattern. The numerical values illustrated in the upper left of the image are OCL values. In FIGS. 7A to 7C, the values of the vertical axis and the horizontal axis are given by arbitrary units.

In FIGS. 7A and 7C, the stripe patterns of the fingerprint clearly appears, and the eigenvalues and the eigenvectors are appropriately extracted along the stripe pattern. Therefore, high OCL values are acquired in the depths D1 and D3. On the other hand, in FIG. 7B, the stripe pattern of the fingerprint is blurred, and the direction of the eigenvector is not appropriately selected. Therefore, a low OCL value is acquired at the depth D2. Thus, it is understood that the OCL value corresponds well to the sharpness of the actual pattern, and by extracting the first feature amount based on the sharpness of the stripe pattern such as the OCL value, it is possible to acquire the extraction depth suitable for extraction of the pattern of the skin.

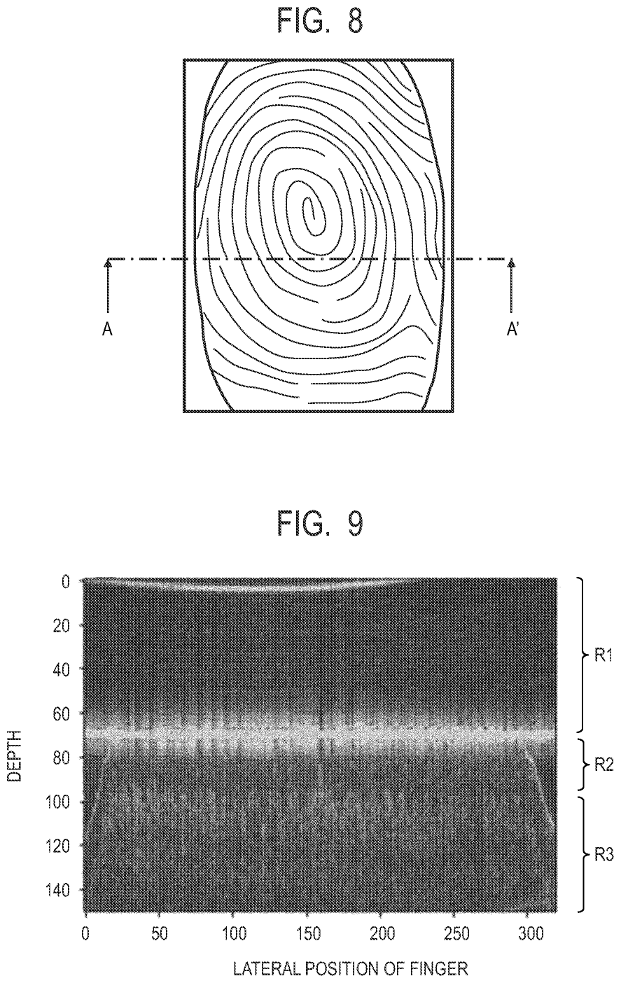

Next, a specific example of extraction of the second feature amount will be described. FIGS. 8 to 10 are diagrams illustrating an example of calculation of the second feature amount executed in the information processing apparatus 1 according to this example embodiment. FIG. 8 is a schematic diagram illustrating an example of the fingerprint image. FIG. 9 is a tomographic image of the finger taken along a line A-A′ of FIG. 8. In FIG. 9, the vertical axis represents the depth and the horizontal axis represents the lateral position of the finger. The shading in FIG. 9 illustrates luminance based on backscattered light at each position.

A range R1 illustrated in FIG. 9 indicates a range in which the glass of the measurement table to which the finger is pressed at the time of photographing by the three-dimensional measuring apparatus 2 exists. A range R2 represents a range corresponding to the epidermis of the finger. A range R3 represents a range corresponding to the dermis of the finger. As can be understood from FIG. 9, the luminance rapidly changes at the boundary between the range R1 and the range R2, the boundary between the range R2 and the range R3, and the like. In FIG. 9, the values of the vertical axis and the horizontal axis are given by arbitrary units.

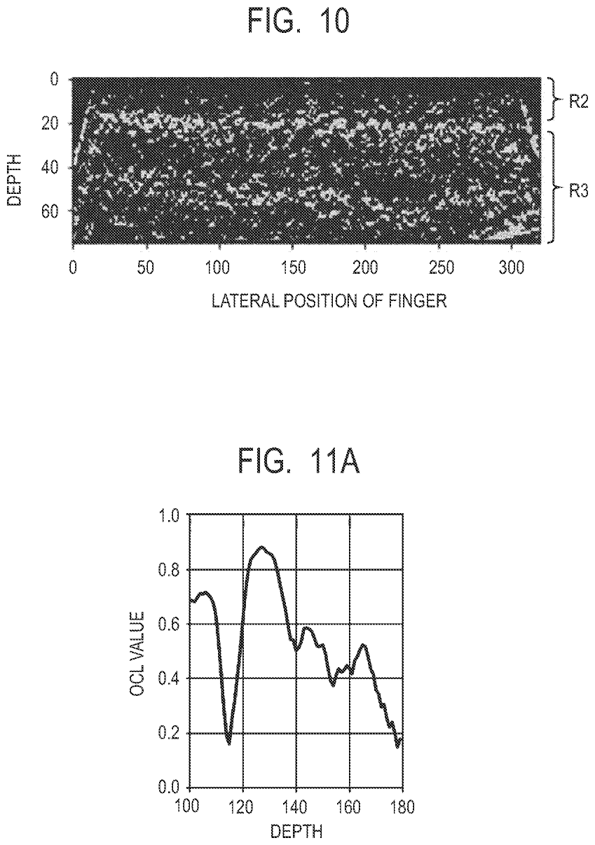

FIG. 10 illustrates an example of edge detection processing in the tomographic image of FIG. 9. In FIG. 10, the vertical axis represents the depth and the horizontal axis represents the lateral position of the finger. The shading in FIG. 10 indicates a binary value acquired by binarizing a luminance gradient in the z direction (differential or difference of luminance values in the z direction) which can be calculated from the data in FIG. 9 with a predetermined threshold as a boundary. In FIG. 10, the range R1 outside the finger is omitted. Also in FIG. 10, the values of the vertical axis and the horizontal axis are given by arbitrary units.

As illustrated in FIG. 10, at the boundary between the range R2 and the range R3, that is, in the vicinity of the surface of the dermis, there are many dots indicating that the luminance gradient is large. Therefore, by counting the number of dots in a predetermined gradient extraction region, the second feature amount can be extracted. Since the number of dots in the gradient extraction region is a value corresponding to the density of dots, it can be said that the larger this value, the steeper the luminance change in the region, and the higher the possibility of the surface of the dermis. Therefore, by acquiring the depth at which the number of dots in the gradient extraction region is large, it is possible to acquire the extraction depth suitable for extraction of the pattern of the skin. The gradient extraction region may be, for example, a thin plate-like region having a predetermined thickness in the depth direction. The thickness of the gradient extraction region in the depth direction can be appropriately set in consideration of the thickness of the epidermis layer, resolution in the depth direction, and the like, and can be, for example, about 7 μm.

As described above, the information processing apparatus 1 according to this example embodiment acquires the first feature amount from the luminance data of the first plane facing the surface of the skin, and further acquires the second feature amount from the luminance data of the second plane including the depth direction of the skin. The reason why the extraction depth is calculated using two kinds of feature amounts having different detection directions will be described.

For example, when the detection target is a fingerprint, the fingerprint near the center of the finger often has a spiral shape, a concentric circle shape, or the like. Further, a part of the fingerprint may be in the shape of a delta. In some cases, the sweat glands are large and the fingerprints are not thin lines. Thus, fingerprints may include portions that are not flowing in one direction. As described above, the pattern of the skin is not always uniform in the planar direction. In such a case, if the information included in the feature amount is based only on the direction along the plane facing the surface of the skin, the accuracy of calculating the extraction depth may not be sufficiently acquired.

On the other hand, in this example embodiment, the extraction depth is calculated by further using the second feature amount acquired from the luminance data of the second plane including the depth direction of the skin, and thus it is possible to calculate the extraction depth considering not only the information of the plane direction of the skin but also the information of the depth direction. Therefore, according to this example embodiment, there is provided an information processing apparatus capable of increasing the accuracy of biometric information based on the pattern of the skin.

As described with reference to FIGS. 9 and 10, although not essential, it is more desirable to acquire the second feature amount based on the luminance gradient in the depth direction of the skin. By using the luminance gradient, the edge of the luminance distribution can be extracted with high accuracy as compared with the case of using the luminance itself. Therefore, it is possible to improve the accuracy of the biometric information based on the pattern of the skin.

In the above description, an example of calculating the OCL value is indicated as an example of calculating the first feature amount, and an example of counting the number of dots in the gradient extraction region is indicated as an example of calculating the second feature amount. However, the first feature amount and the second feature amount may be acquired by scoring the amounts calculated from the three-dimensional luminance data by a predetermined function.

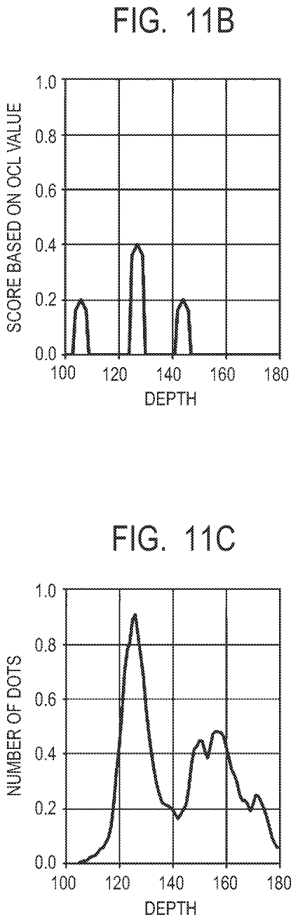

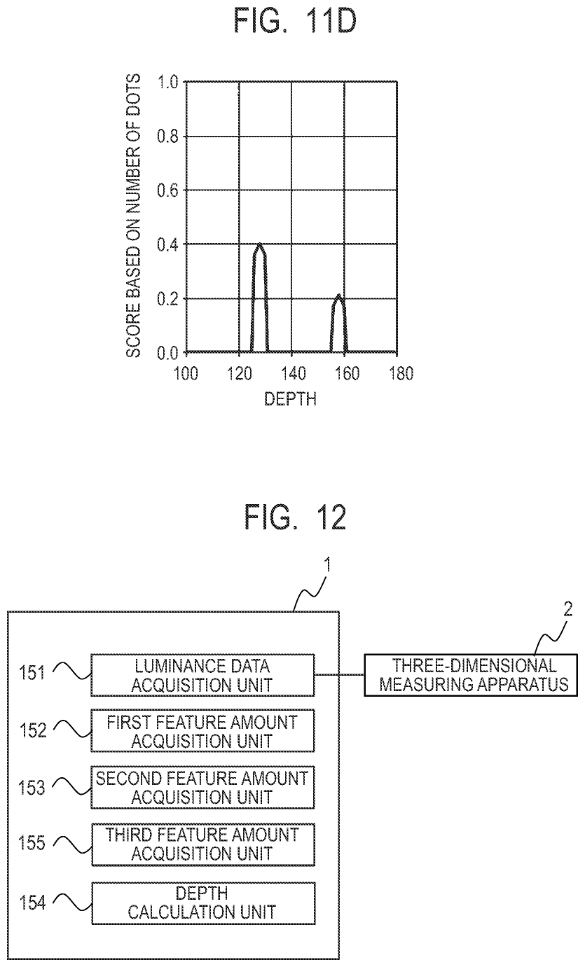

FIGS. 11A to 11D are graphs illustrating calculation examples of scores in the information processing apparatus 1 according to this example embodiment. In the graphs of FIGS. 11A to 11D, the values of the vertical axis and the horizontal axis are given by arbitrary units.

FIG. 11A illustrates an example of the calculation result of the OCL value. Although FIG. 11A is based on data different from FIG. 6 and the form of the graph is different, the view of the data is the same, and therefore description thereof is omitted.

FIG. 11B is a graph illustrating scores calculated based on the OCL value of FIG. 11A. The vertical axis of FIG. 11B is a score acquired by converting the OCL value of FIG. 11A using a predetermined function. This function can be appropriately set so that a characteristic portion such as a peak of the OCL value can be extracted. Referring to FIG. 11B, peaks are seen near depths 106, 126, and 144.

FIG. 11C is a graph acquired by plotting the number of dots in the gradient extraction region acquired by the edge detection processing illustrated in FIG. 10 with respect to the depth. The vertical axis of FIG. 11C is a value acquired by normalizing the number of dots in the gradient extraction region by a predetermined coefficient. The horizontal axis of FIG. 11C represents the depth of the finger.

FIG. 11D is a graph illustrating scores calculated based on the number of dots in FIG. 11C. The vertical axis in FIG. 11B is a score acquired by converting the number of dots in FIG. 11C using a predetermined function. This function can be appropriately set so that a characteristic portion such as a peak of the number of dots can be extracted. Referring to FIG. 11D, peaks are seen near depths 126 and 158. When the results of FIGS. 11B and 11D are summarized, it can be seen that the depth 126 is the most suitable depth for extraction of a pattern. As described above, the first feature amount and the second feature amount may be values acquired by scoring the amount calculated from the three-dimensional luminance data by a predetermined function.

### Second Example Embodiment

An information processing apparatus 1 according to this example embodiment will be described with reference to FIGS. 12 to 16. The information processing apparatus 1 of this example embodiment is different from the first example embodiment in that the information processing apparatus 1 further acquires a third feature amount based on continuity of at least one of the first feature amount and the second feature amount. The description of elements common to those of the first example embodiment may be omitted or simplified.

FIG. 12 is a functional block diagram of the information processing apparatus 1 according to this example embodiment. In addition to the configuration of FIG. 2, the information processing apparatus 1 further includes a third feature amount acquisition unit 155. The processor 101 realizes a function of the third feature amount acquisition unit 155 by executing a program stored in the memory 102. The third feature amount acquisition unit 155 may be more generally referred to as a third acquisition means.

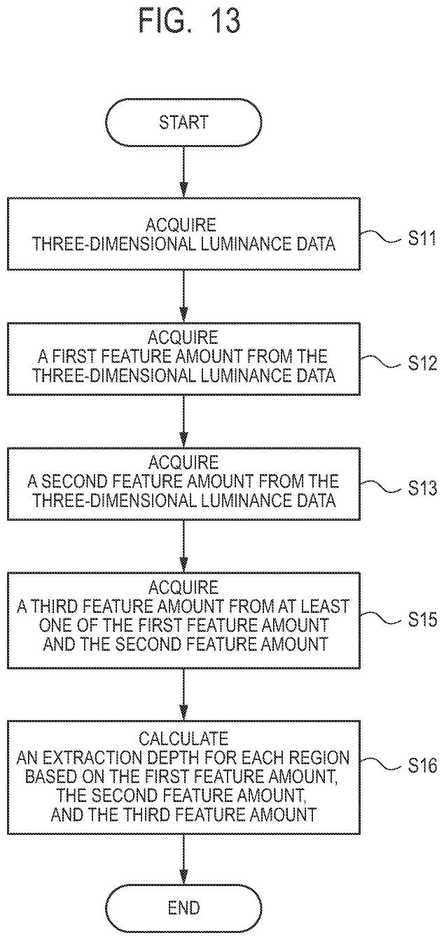

FIG. 13 is a flowchart illustrating an outline of the extraction depth calculation executed in the information processing apparatus 1 according to this example embodiment. Since the processing in steps S11 to S13 is similar to that in the first example embodiment, the description thereof will be omitted.

In step S15, the third feature amount acquisition unit 155 acquires a third feature amount. Here, the third feature amount is a feature amount based on continuity of at least one of the first feature amount and the second feature amount.

In step S16, the depth calculation unit 154 calculates an extraction depth for each region in the three-dimensional luminance data based on the first feature amount, the second feature amount, and the third feature amount.

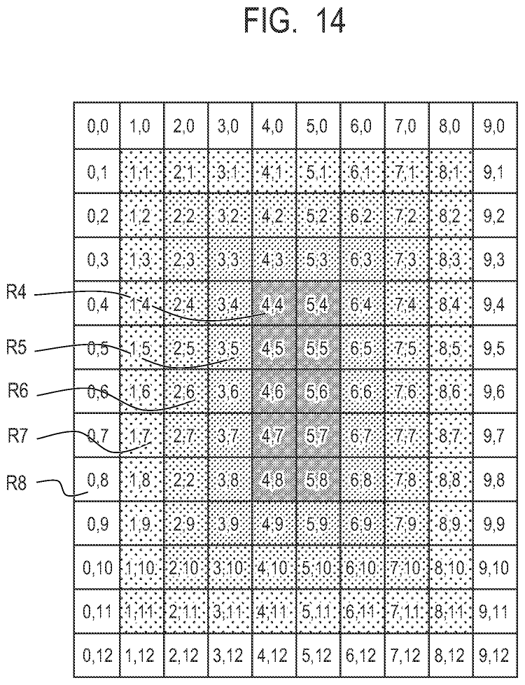

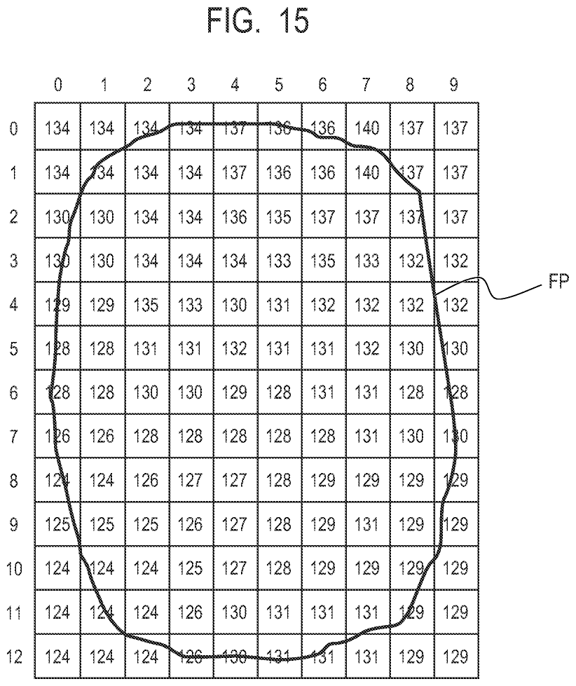

Next, with reference to FIGS. 14 and 15, an example of a specific processing of acquiring the third feature amount will be described. FIG. 14 is a diagram illustrating an example of calculation of a third feature amount executed in the information processing apparatus 1 according to this example embodiment. A plurality of frames illustrated in FIG. 14 schematically illustrate a region division of the xy plane illustrated in FIG. 5(b). The numerical values in the frames are region numbers indicating the positions in the x direction and the y direction, and the gradations in the frames indicate the setting order of the values of the third feature amounts.

The deepest region R4 near the center of FIG. 14 is the first setting region. First, the value of the third feature amount of the region R4 is arbitrary set. Next, the value of the third feature amount of the region R5 adjacent to the outside of R4 is set. This setting is performed as follows.

First, the extraction depth is estimated with reference to at least one value of the first feature amount and the second feature amount for each of the region R4 and the region R5. Then, the difference between the extraction depths of the region R4 and the region R5 is calculated. Further, the value of the third feature amount of the region R5 is set so that the value of the third feature amount becomes higher as the difference between the extraction depths of the region R4 and the region R5 becomes smaller.

Next, the value of the third feature amount of the region R6 adjacent to the outside of the region R5 is set. In this processing, similarly to the above, the value of the third feature amount of the region R6 is set so that the value of the third feature amount becomes higher as the difference between the extraction depths of the region R5 and the region R6 becomes smaller. Similarly, the values of the third feature amounts are sequentially set for the regions R7 and R8.

As described above, the third feature amount of this example embodiment is set so that, in order from the inner side, the smaller the difference in the extraction depth between the regions and the higher the continuity, the higher the value. By calculating the extraction depth in step S16 using the third feature amount, a correction is applied to reduce the difference in the extraction depth between regions as compared with the case of using only the first feature amount and the second feature amount.

The effect of using the third feature amount acquired as described above will be described. FIG. 15 is a diagram illustrating an example of calculation of the extraction depth executed in the information processing apparatus 1 according to this example embodiment. FIG. 15 illustrates the positional relationship between the distribution of the extraction depth of each region and the fingerprint detection range FP. The numerical values written in the boxes indicating the respective regions in FIG. 15 are the extraction depths. For example, as illustrated in FIG. 15, the extraction depth varies generally continuously from near the center of the finger toward the outside. This may be due to the thickness distribution of the epidermis due to physiological factors, and this tendency may appear due to the fact that the epidermis is partially compressed and thinned by pressing the finger against the measurement table during fingerprint imaging.

As described above, the depth suitable for extraction of a pattern inside the skin such as a dermal fingerprint does not change rapidly with respect to the plane direction, but generally has a continuous distribution to some extent. However, the first feature amount and the second feature amount are calculated based on local information, and this continuity may not be considered sufficiently. Therefore, it is desirable to further use the third feature amount in consideration of continuity. Accordingly, this example embodiment provides an information processing apparatus capable of increasing the accuracy of biometric information based on the pattern of the skin by acquiring the third feature amount calculated so as to take the continuity of the first feature amount and the second feature amount into consideration and using the third feature amount for calculating the extraction depth.

The method of acquiring the third feature amount is not limited to that described with reference to FIG. 14, and may be acquired by an algorithm other than that described above. For example, in the above-described example, the value of the third feature amount is set in consideration of only the extraction depths of adjacent regions (for example, regions R4 and R5), but the extraction depth difference of two or more regions apart from each other (for example, regions R4 and R6) may be considered. Further, for example, a difference in the extraction depth between regions having the same setting priority may be taken into consideration, such as one region of the region R5 and another region of the region R5.

Further, the position of the region (the region R4 in the example of FIG. 14) in which the setting is first performed in the acquisition of the third feature amount may be determined in advance, or may be variable according to the distribution of the biometric information such as the three-dimensional luminance data and the feature amount. For example, a region in which at least one value of the first feature amount and the second feature amount is maximum may be used as the initial setting region, and a center of an effective range (for example, a range in which the finger is detected) acquired from a luminance distribution in the xy plane of the three-dimensional luminance data may be used as the initial setting region. Thus, since the distribution of the biometric information is considered in the process of acquiring the third feature amount, the biometric information based on the pattern of the skin can be made more accurate.

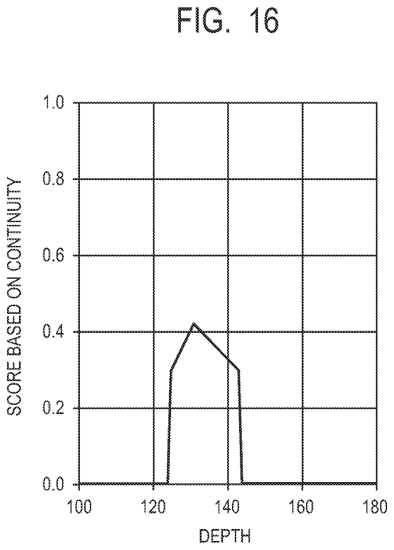

Similarly to the first feature amount and the second feature amount, the value of the third feature amount may also be scored by a predetermined function. FIG. 16 is a graph illustrating an example of score calculation in the information processing apparatus 1 according to this example embodiment. In the graph of FIG. 16, the values of the vertical axis and the horizontal axis are given by arbitrary units.

FIG. 16 illustrates an example of the calculation result of the score based on the continuity of the third feature amount, that is, at least one of the first feature amount and the second feature amount. The vertical axis of FIG. 16 is a score acquired by converting the third feature amount using a predetermined function. Thus, similar to the first feature amount and the second feature amount, the third feature amount may also be scored. By scoring the third feature amount in the same manner as the first feature amount and the second feature amount, it is possible to easily integrate the first feature amount, the second feature amount, and the third feature amount and calculate the depth of extraction.

### Third Example Embodiment

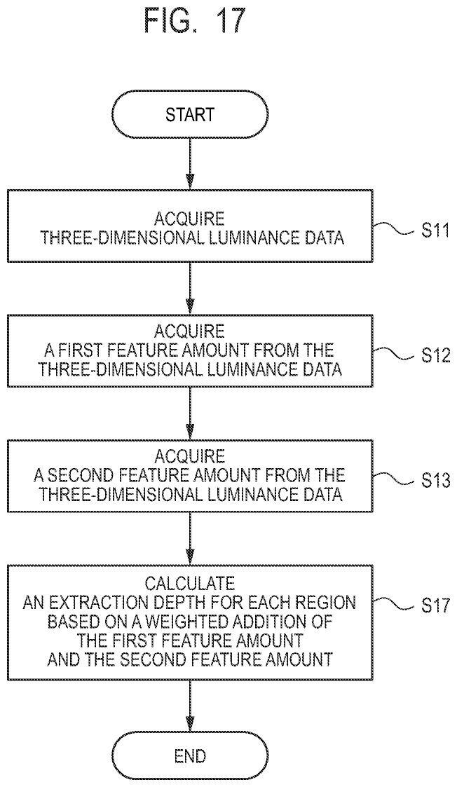

An information processing apparatus 1 according to this example embodiment will be described with reference to FIG. 17. The information processing apparatus 1 of this example embodiment differs from the first example embodiment in that a value acquired by a weighted addition of the first feature amount and the second feature amount is used for calculation of an extraction depth. The description of elements common to those of the first example embodiment may be omitted or simplified.

FIG. 17 is a flowchart illustrating an outline of an extraction depth calculation executed in the information processing apparatus 1 according to this example embodiment. Since the processing in steps S11 to S13 is similar to that in the first example embodiment, the description thereof will be omitted.

In step S17, the depth calculation unit 154 calculates an extraction depth for each region in the three-dimensional luminance data based on a weighted addition of the first feature amount and the second feature amount. In this processing, for example, scores as illustrated in FIGS. 11B and 11D may be weighted and added to acquire a score after weighted addition, and the extraction depth may be calculated based on the score.

In this example embodiment, by appropriately setting coefficients used for weighting, the first feature amount and the second feature amount can be taken into account, and a ratio in which these feature amounts are taken into account can be changed. Therefore, adjustment can be performed by using this coefficient as a parameter so as to acquire a more suitable extraction depth. Therefore, according to this example embodiment, there is provided an information processing apparatus capable of increasing the accuracy of biometric information based on the pattern of the skin.

### Fourth Example Embodiment

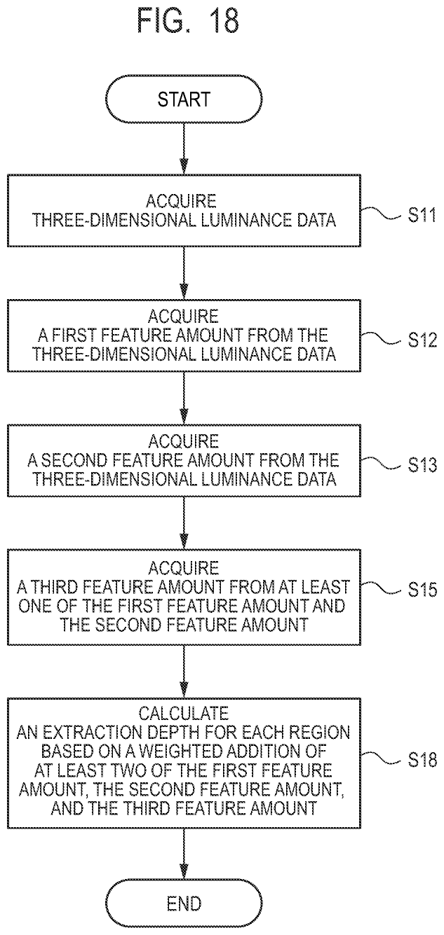

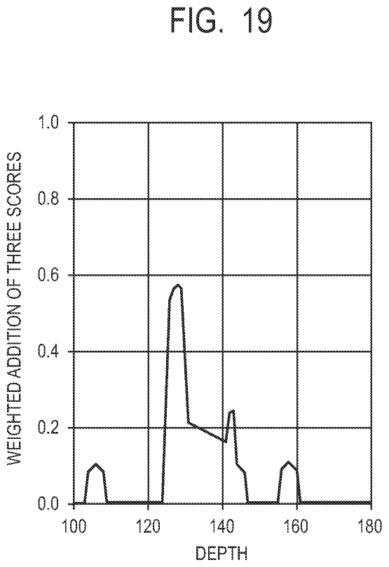

An information processing apparatus 1 according to this example embodiment will be described with reference to FIGS. 18 and 19. The information processing apparatus 1 of this example embodiment differs from the second and third example embodiments in that a value acquired by a weighted addition of at least two of the first feature amount, the second feature amount, and the third feature amount is used for calculation of an extraction depth. The description of elements common to any of the first to third example embodiments may be omitted or simplified.

FIG. 18 is a flowchart illustrating an outline of an extraction depth calculation executed in the information processing apparatus 1 according to this example embodiment. Since the processing in steps S11 to S13 is similar to that in the first example embodiment, the description thereof will be omitted. Since the processing in step S15 is similar to that in the second example embodiment, the description thereof will be omitted.

In step S18, the depth calculation unit 154 calculates an extraction depth for each region in the three-dimensional luminance data based on a weighted addition of at least two of the first feature amount, the second feature amount, and the third feature amount. In this processing, for example, scores as illustrated in FIGS. 11B, 11D, and 16 may be weighted and added to acquire a score after weighted addition, and the extraction depth may be calculated based on the score.

FIG. 19 is a graph illustrating an example of score calculation in the information processing apparatus 1 according to this example embodiment. In the graph of FIG. 19, the values of the vertical axis and the horizontal axis are given by arbitrary units. The vertical axis of FIG. 19 is a score acquired by a weighted addition of the three scores of FIGS. 11B, 11D, and 16. As illustrated in FIG. 19, since a peak having a maximum height is observed in the vicinity of the depth 126, it can be understood that the depth 126 is a preferable extraction depth.

In this example embodiment, by appropriately setting coefficients used for weighting, the first feature amount, the second feature amount, and the third feature amount can be taken into account, and a ratio in which the first feature amount, the second feature amount, and the third feature amount are taken into account can be changed. Therefore, adjustment can be performed by using this coefficient as a parameter so as to acquire a more suitable extraction depth. Therefore, according to this example embodiment, there is provided an information processing apparatus capable of increasing the accuracy of biometric information based on the pattern of the skin.

### Fifth Example Embodiment

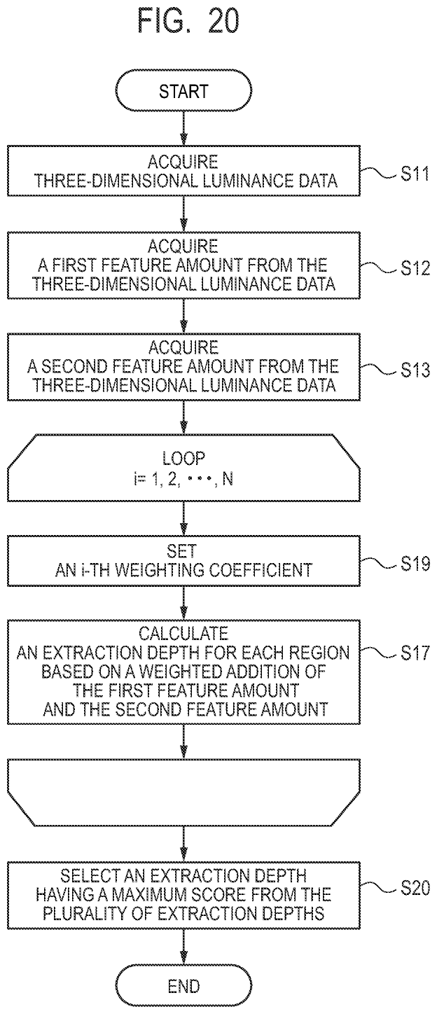

An information processing apparatus 1 according to this example embodiment will be described with reference to FIG. 20. The information processing apparatus 1 of this example embodiment differs from the third example embodiment in that a plurality of types of weighted addition are performed using a plurality of sets of weighting coefficients. The description of elements common to the first example embodiment or the third example embodiment may be omitted or simplified.

FIG. 20 is a flowchart illustrating an outline of an extraction depth calculation executed in the information processing apparatus 1 according to this example embodiment. Since the processing in steps S11 to S13 is similar to that in the first example embodiment, the description thereof will be omitted.

Steps S19 and S17 are loop processing for sequentially calculating extraction depths for N different sets of weighting coefficients. “N” is an integer equal to or greater than 2, and is a value indicating the number of times of execution of the loop. “i” is an integer equal to or greater than 1 and equal to or less than N, and is a loop counter of this loop processing.

In step S19, the depth calculation unit 154 sets an i-th weighting coefficient. The weighting coefficient may be set in advance or based on user input.

In step S17, the depth calculation unit 154 calculates an extraction depth for each region in the three-dimensional luminance data based on a weighted addition of the first feature amount and the second feature amount acquired by the i-th weighting coefficient.

In step S20, the depth calculation unit 154 selects an extraction depth having a maximum score from the plurality of extraction depths acquired by the loop processing in steps S19 and S17, and determines the selected extraction depth as a final extraction depth.

In this example embodiment, it is possible to output a more preferable one of the extraction depths acquired by a plurality of weighting coefficients. Therefore, according to this example embodiment, there is provided an information processing apparatus capable of increasing the accuracy of biometric information based on the pattern of the skin.

### Sixth Example Embodiment

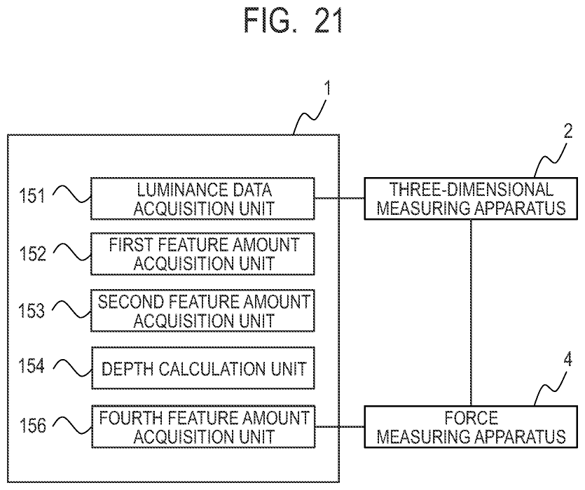

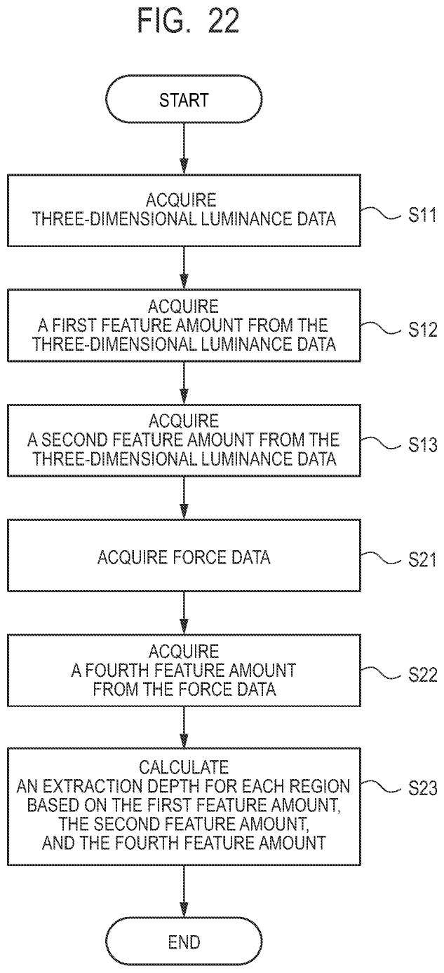

An information processing apparatus 1 according to this example embodiment will be described with reference to FIGS. 21 and 22. The information processing apparatus 1 of this example embodiment is different from the first example embodiment in that the information processing apparatus 1 further acquires a fourth feature amount based on a force received by a measuring surface from the skin when measuring three-dimensional luminance data. The description of elements common to those of the first example embodiment may be omitted or simplified.

FIG. 21 is a functional block diagram of the information processing apparatus 1 according to this example embodiment. In addition to the configuration of FIG. 2, the information processing apparatus 1 further includes a fourth feature amount acquisition unit 156. The processor 101 realizes a function of the fourth feature amount acquisition unit 156 by executing a program stored in the memory 102. The fourth feature amount acquisition unit 156 acquires a fourth feature amount based on force data measured by a force measuring apparatus 4. The fourth feature amount acquisition unit 156 may be more generally referred to as a fourth acquisition means.

The force measuring apparatus 4 measures a force received from the skin by a measuring surface when measuring three-dimensional luminance data. The force measuring apparatus 4 may be, for example, a force sensor provided on a measurement table of the three-dimensional measuring apparatus 2. The force sensor measures a force received by the measurement table when a skin such as a finger is pressed against the measurement table.

The force measuring apparatus 4 may be, for example, a displacement sensor that measures the displacement of the measurement table of the three-dimensional measuring apparatus 2. Since the displacement amount measured by the displacement sensor is a value corresponding to the force received by the measurement table, the force received by the measuring surface from the skin can be substantially measured even in this configuration. The displacement amount can be regarded as the force data in a process described later.

Further, since the three-dimensional measuring apparatus 2 can measure the position of the measuring table based on the distribution of luminance, the three-dimensional measuring apparatus 2 itself can measure the displacement of the measuring table instead of the displacement sensor of the above-described example. Therefore, even in this configuration, the force received by the measuring surface from the skin can be substantially measured. In this case, the three-dimensional measuring apparatus 2 can also function as the force measuring apparatus 4.

FIG. 22 is a flowchart illustrating an outline of the extraction depth calculation executed in the information processing apparatus 1 according to this example embodiment. Since the processing in steps S11 to S13 is similar to that in the first example embodiment, the description thereof will be omitted.

In step S21, the fourth feature amount acquisition unit 156 acquires force data measured by the force measuring apparatus 4.

In step S22, the fourth feature amount acquisition unit 156 acquires a fourth feature amount based on the force data. The fourth feature amount may be a force received by the measurement table, a displacement of the measurement table based on the force received by the measurement table, or a score calculated from the force or displacement.

In step S23, the depth calculation unit 154 calculates an extraction depth for each region in the three-dimensional luminance data based on the first feature amount, the second feature amount, and the fourth feature amount.

When the skin is pressed against the measurement table during the measurement, the skin is compressed and becomes thin. In this case, the depth of extraction suitable for extraction of the pattern is shallower than that in the case where the pattern is not pressed. A suitable amount of change in the extraction depth due to this phenomenon varies depending on the magnitude of the force applied to the skin. In this example embodiment, since the fourth feature amount based on the force received from the skin by the measurement surface during the measurement of the three-dimensional luminance data is included in the calculation of the extraction depth, the influence of compression of the epidermis is considered more appropriately. Thus, according to this example embodiment, there is provided an information processing apparatus capable of increasing the accuracy of biometric information based on the pattern of the skin.

### Seventh Example Embodiment

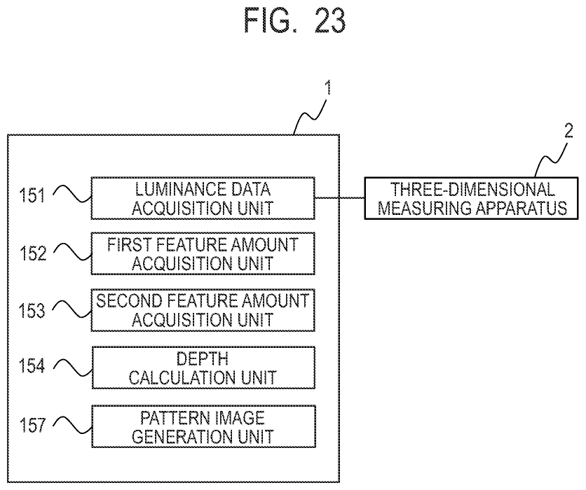

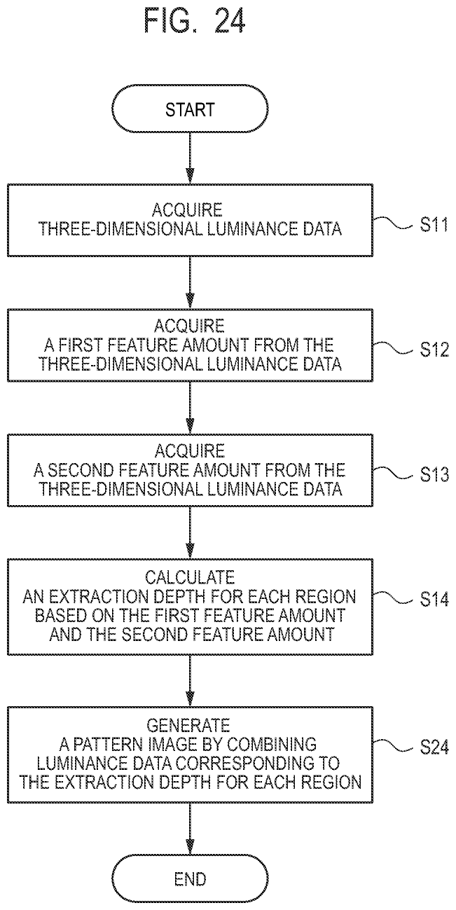

An information processing apparatus 1 according to this example embodiment will be described with reference to FIGS. 23 and 24. The information processing apparatus 1 of this example embodiment is different from the first example embodiment in that a pattern image is generated based on the extraction depth. The description of elements common to those of the first example embodiment may be omitted or simplified.

FIG. 23 is a functional block diagram of the information processing apparatus 1 according to this example embodiment. In addition to the configuration of FIG. 2, the information processing apparatus 1 further includes a pattern image generation unit 157. The processor 101 executes a program stored in the memory 102 to realize a function of the pattern image generation unit 157. The pattern image generation unit 157 may be referred to as an image generation means.

FIG. 24 is a flowchart illustrating an outline of generation of a pattern image executed in the information processing apparatus 1 according to this example embodiment. Since the processing in steps S11 to S14 is similar to that in the first example embodiment, the description thereof will be omitted.

In step S24, the pattern image generation unit 157 generates a pattern image by combining luminance data corresponding to the extraction depth for each region. The pattern image is an image illustrating the pattern of the skin on the xy plane, specifically, an image illustrating the unevenness of the fingerprint as illustrated in FIG. 8.

The pattern image acquired by the processing of this example embodiment can be used as biometric information for biometric authentication such as fingerprint authentication. The pattern image acquired in this example embodiment may be an image for preliminary registration acquired at the time of registration of biometric information or an image for authentication acquired at the time of authentication. In other words, the information processing apparatus 1 of this example embodiment may function as a biometric information registration apparatus or a biometric authentication apparatus. The pattern image is generated using luminance data of an appropriate extraction depth. Accordingly, a pattern image in which the pattern of the skin appears more appropriately is acquired. As described above, according to this example embodiment, it is possible to provide an information processing apparatus capable of acquiring a pattern image based on the pattern of the skin with higher accuracy.

### Eighth Example Embodiment

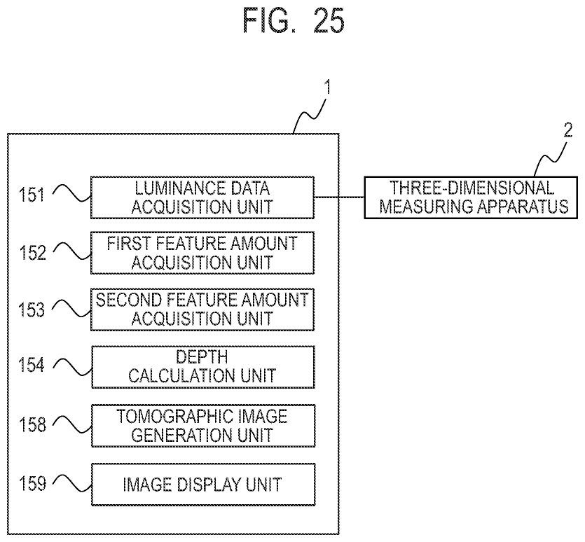

An information processing apparatus 1 according to this example embodiment will be described with reference to FIGS. 25 to 27. The information processing apparatus 1 of this example embodiment differs from the first example embodiment in that the information processing apparatus 1 can display an image in which a tomographic image and information indicating an extraction depth are superimposed. The description of elements common to those of the first example embodiment may be omitted or simplified.

FIG. 25 is a functional block diagram of the information processing apparatus 1 according to this example embodiment. In addition to the configuration of FIG. 2, the information processing apparatus 1 further includes a tomographic image generation unit 158 and an image display unit 159. The processor 101 realizes a function of the tomographic image generation unit 158 by executing a program stored in the memory 102. The processor 101 controls a display device, which is a kind of the output device 105, thereby realizing a function of the image display unit 159. The image display unit 159 may be more generally referred to as a display means.

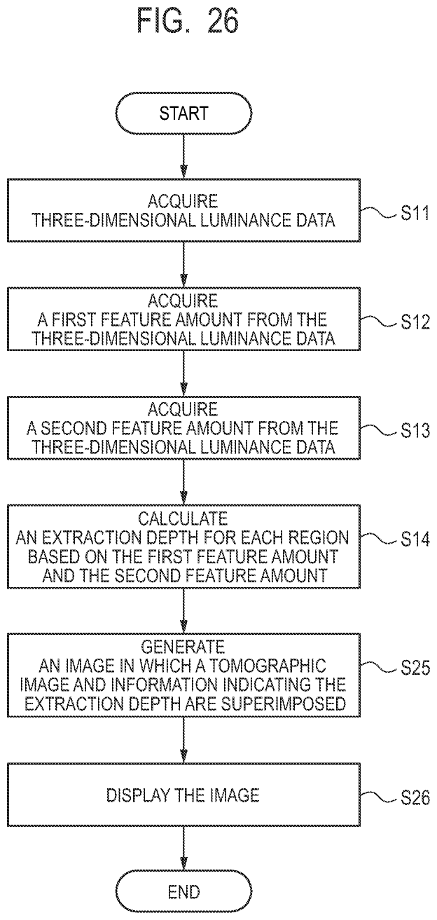

FIG. 26 is a flowchart illustrating an outline of tomographic image display executed by the information processing apparatus 1 according to this example embodiment. Since the processing in steps S11 to S14 is similar to that in the first example embodiment, the description thereof will be omitted.

In step S25, the tomographic image generation unit 158 generates a tomographic image based on luminance data on a predetermined cross-sectional line. The tomographic image is an image illustrating a luminance distribution in a plane including at least the depth direction, and specifically, can be as illustrated in FIG. 9. Then, the tomographic image generation unit 158 generates an image in which information indicating an extraction depth is superimposed on the tomographic image. The information indicating the extraction depth may be, for example, a line arranged at a position corresponding to the extraction depth.

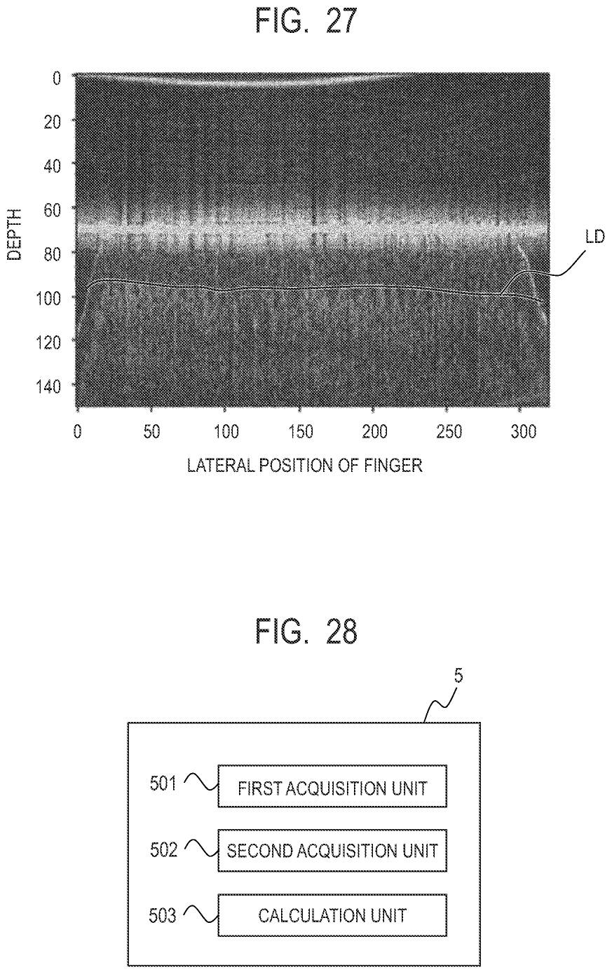

In step S26, the image display unit 159 displays the image generated in step S25 on a display unit of a display device. FIG. 27 is a diagram illustrating an example of an image displayed in the information processing apparatus 1 according to this example embodiment. As illustrated in FIG. 27, an image on which a curved line LD indicating a position corresponding to an extraction depth of a tomographic image is superimposed may be displayed as information indicating an extraction depth.

According to this example embodiment, there is provided an information processing apparatus capable of easily presenting information of the calculated extraction depth to a user.

Note that the display form of the information indicating the extraction depth is not limited to that illustrated in FIG. 27. For example, the position of the extraction depth may be indicated by an arrow instead of the curved line LD, or a numerical value of the extraction depth may be displayed.

The apparatus described in the above example embodiments can also be configured as in a ninth example embodiment as follows.

### Ninth Example Embodiment

FIG. 28 is a functional block diagram of an information processing apparatus 5 according to a ninth example embodiment. The information processing apparatus 5 includes a first acquisition unit 501, a second acquisition unit 502, and a calculation unit 503. The first acquisition unit 501 acquires a first feature amount acquired from luminance data of a first plane facing a surface of a skin among three-dimensional luminance data of the skin. The second acquisition unit 502 acquires a second feature amount acquired from luminance data of a second plane including a depth direction of the skin among the three-dimensional luminance data. The calculation unit 503 calculates an extraction depth for extraction of a pattern of the skin based on the first feature amount and the second feature amount.

According to this example embodiment, it is possible to provide the information processing apparatus 5 capable of increasing the accuracy of the biometric information based on the pattern of the skin.

### Modified Example Embodiments

This disclosure is not limited to the above-described example embodiments, and can be appropriately modified without departing from the gist of this disclosure. For example, examples in which some of the configurations of any of the example embodiments are added to another example embodiment or examples in which some of the configurations of any of the example embodiments are replaced with some of another example embodiment are also example embodiments of this disclosure.

A processing method in which a program for operating the configuration of the above-described example embodiments is stored in a storage medium so as to realize the functions of the above-described example embodiment, the program stored in the storage medium is read out as a code, and executed in a computer is also included in the scope of each example embodiment. That is, a computer-readable storage medium is also included in the scope of each example embodiment. In addition, not only the storage medium storing the above-described program but also the program itself are included in each example embodiment. Further, one or more components included in the above example embodiment may be a circuit such as an application specific integrated circuit (ASIC) and a field programmable gate array (FPGA) configured to realize the functions of the components.

Examples of the storage medium include a floppy disk, a hard disk, an optical disk, a magneto-optical disk, a compact disk (CD)-ROM, a magnetic tape, a non-volatile memory card, and a ROM. In addition, the scope of each example embodiment includes not only a system in which a program stored in the storage medium is executed by itself but also a system in which a program is executed by operating on an operating system (OS) in cooperation with other software and functions of an expansion board.

The service implemented by the functions of the above-described example embodiments can also be provided to the user in the form of software as a service (SaaS).

The whole or part of the example embodiments disclosed above can be described as, but not limited to, the following supplementary notes.

(Supplementary note 1)

An information processing apparatus comprising:
a first acquisition means for acquiring a first feature amount acquired from luminance data of a first plane facing a surface of a skin among three-dimensional luminance data of the skin;
a second acquisition means for acquiring a second feature amount acquired from luminance data of a second plane including a depth direction of the skin among the three-dimensional luminance data; and
a calculation means for calculating an extraction depth for extraction of a pattern of the skin based on the first feature amount and the second feature amount.
   (Supplementary note 2)

The information processing apparatus according to supplementary note 1, wherein the calculation means calculates the extraction depth based on a value acquired by performing a weighted addition of the first feature amount and the second feature amount by a predetermined weight.

(Supplementary note 3)

The information processing apparatus according to supplementary note 2, wherein the calculation means calculates the extraction depth based on a plurality of values acquired by performing the weight addition using a plurality of different weights.

(Supplementary note 4)

The information processing apparatus according to any one of supplementary notes 1 to 3 further comprising a third acquisition means for acquiring a third feature amount based on continuity, between regions of the three-dimensional luminance data, of at least one of the first feature amount and the second feature amount, wherein the calculation means calculates the extraction depth further based on the third feature amount.

(Supplementary note 5)

The information processing apparatus according to any one of supplementary notes 1 to 4, wherein the second acquisition means acquires the second feature amount based on a luminance gradient in the depth direction of the skin.

(Supplementary note 6)

The information processing apparatus according to any one of supplementary notes 1 to 5 further comprising a fourth acquisition means for acquiring a fourth feature amount based on a force received by a measuring surface from the skin when measuring the three-dimensional luminance data,
wherein the calculation means calculates the extraction depth further based on the fourth feature amount.
   (Supplementary note 7)

The information processing apparatus according to any one of supplementary notes 1 to 6 further comprising an image generation means for generating a pattern image by combining luminance data at the extraction depth calculated from each of a plurality of regions of the three-dimensional luminance data.

(Supplementary note 8)

The information processing apparatus according to any one of supplementary notes 1 to 7 further comprising a display means for displaying a tomographic image based on luminance data on the second plane and information indicating the extraction depth that are superimposed on each other.

(Supplementary note 9)

An information processing method comprising:
acquiring a first feature amount acquired from luminance data of a first plane facing a surface of a skin among three-dimensional luminance data of the skin;
acquiring a second feature amount acquired from luminance data of a second plane including a depth direction of the skin among the three-dimensional luminance data; and
calculating an extraction depth for extraction of a pattern of the skin based on the first feature amount and the second feature amount.
   (Supplementary note 10)

A storage medium storing a program for causing a computer to execute an information processing method comprising:
acquiring a first feature amount acquired from luminance data of a first plane facing a surface of a skin among three-dimensional luminance data of the skin;
acquiring a second feature amount acquired from luminance data of a second plane including a depth direction of the skin among the three-dimensional luminance data; and
calculating an extraction depth for extraction of a pattern of the skin based on the first feature amount and the second feature amount.

This application is based upon and claims the benefit of priority from Japanese Patent Application No. 2021-043015, filed on Mar. 17, 2021, the disclosure of which is incorporated herein in its entirety by reference.

### REFERENCE SIGNS LIST

1 and 5 information processing apparatus
2 three-dimensional measuring apparatus
3 object
4 force measuring apparatus
101 processor
102 memory
103 communication I/F
104 input device
105 output device
151 luminance data acquisition unit
152 first feature amount acquisition unit
153 second feature amount acquisition unit
154 depth calculation unit
155 third feature amount acquisition unit
156 fourth feature amount acquisition unit
157 pattern image generation unit
158 tomographic image generation unit
159 image display unit
201 controller
202 light source
203 beam splitter
204 reference light mirror
205 scanner head
206 photodetector
207 measurement table
208 guide
501 first acquisition unit
502 second acquisition unit
503 calculation unit

What is claimed is:

1. An information processing apparatus comprising:
a memory configured to store instructions; and
a processor configured to execute the instructions to:
acquire a first feature amount acquired from luminance data of a first plane facing a surface of a skin among three-dimensional luminance data of the skin;
acquire a second feature amount acquired from luminance data of a second plane including a depth direction of the skin among the three-dimensional luminance data; and
calculate an extraction depth for extraction of a pattern of the skin based on the first feature amount and the second feature amount.

2. The information processing apparatus according to claim 1, wherein the extraction depth is calculated based on a value acquired by performing a weighted addition of the first feature amount and the second feature amount by a predetermined weight.

3. The information processing apparatus according to claim 2, wherein the extraction depth is calculated based on a plurality of values acquired by performing the weight addition using a plurality of different weights.

4. The information processing apparatus according to claim 1,
wherein the processor is further configured to execute the instructions to acquire a third feature amount based on continuity, between regions of the three-dimensional luminance data, of at least one of the first feature amount and the second feature amount, and
wherein the extraction depth is calculated further based on the third feature amount.

5. The information processing apparatus according to, claim 1, wherein the second feature amount is acquired based on a luminance gradient in the depth direction of the skin.

6. The information processing apparatus according to claim 1,
wherein the processor is further configured to execute the instructions to acquire a fourth feature amount based on a force received by a measuring surface from the skin when measuring the three-dimensional luminance data, and
wherein the extraction depth is calculated further based on the fourth feature amount.

7. The information processing apparatus according to claim 1,
wherein the processor is further configured to execute the instructions to generate a pattern image by combining luminance data at the extraction depth calculated from each of a plurality of regions of the three-dimensional luminance data.

8. The information processing apparatus according to claim 1, wherein the processor is further configured to execute the instructions to generate display information for displaying a tomographic image based on luminance data on the second plane and information indicating the extraction depth that are superimposed on each other.

9. An information processing method comprising:
acquiring a first feature amount acquired from luminance data of a first plane facing a surface of a skin among three-dimensional luminance data of the skin;
acquiring a second feature amount acquired from luminance data of a second plane including a depth direction of the skin among the three-dimensional luminance data; and
calculating an extraction depth for extraction of a pattern of the skin based on the first feature amount and the second feature amount.

10. A non-transitory storage medium storing a program for causing a computer to execute an information processing method comprising:
acquiring a first feature amount acquired from luminance data of a first plane facing a surface of a skin among three-dimensional luminance data of the skin;
acquiring a second feature amount acquired from luminance data of a second plane including a depth direction of the skin among the three-dimensional luminance data; and
calculating an extraction depth for extraction of a pattern of the skin based on the first feature amount and the second feature amount.
